(19) United States
(12) Patent Application Publication
(10) Pub. No.: US 2026/0097950 A1
(43) Pub. Date: Apr. 9, 2026

(54) SYSTEM AND METHOD FOR IMPROVED FUEL DISPENSER AUDIT COMPLIANCE

(71) Applicant: Gilbarco Inc., Greensboro, NC (US)

(72) Inventors: Jonathan Fashandi, Florence (IT); Tara Pandey, Summerfield, NC (US); Nitish Kumar, Oak Ridge, NC (US); Jorge Garay, Ciudad Autonom (AR)

(21) Appl. No.: 19/352,029

(22) Filed: Oct. 7, 2025

Related U.S. Application Data
(60) Provisional application No. 63/704,098, filed on Oct. 7, 2024.

(51) Int. Cl. B67D 7/08; G06Q 40/12

(52) U.S. Cl. CPC B67D 7/085; G06Q 40/124

(57) ABSTRACT

A system for determining fuel dispenser metrological compliance at multiple fueling sites each having a plurality of fuel dispensers. The system comprises a cloud-based computing resource in operative communication with the fueling sites. The cloud-based computing resource is operative to receive a compliance request from a compliance entity for metrological information from a selected fuel dispenser, validate the compliance request, and provide compliance data to the compliance entity.

### CROSS-REFERENCE TO A RELATED APPLICATION

This application is based upon and claims the benefit of provisional application Ser. No. 63/704,098, filed Oct. 7, 2024, incorporated fully herein by reference for all purposes.

### FIELD

The present invention relates generally to fuel dispenser audits and, more particularly, to generating a Category 3 fuel dispenser digital audit report.

### BACKGROUND

Regulatory audit procedures are a requirement in fuel dispenser operations. Until now, metrological entity inspectors (e.g., W&M, Measurement Canada, OIML, etc.) have had to conduct in-person audits of the metrological settings and configurations of fuel dispensers. Under Category 2 (CAT 2) requirements, any updates to pump software must be done by updating hardware in the field following metrological procedures for sealing the unit afterwards. It is typically necessary to use certified personnel to perform such updates. As such, a CAT 2 audit of the dispenser unfortunately requires significant manual intervention and creates a relatively large carbon footprint.

### SUMMARY

According to one aspect, the present invention provides a system for determining fuel dispenser metrological compliance at multiple fueling sites each having a plurality of fuel dispensers. The system comprises a cloud-based computing resource in operative communication with the fueling sites. The cloud-based computing resource is operative to receive a compliance request from a compliance entity for metrological information from a selected fuel dispenser, validate the compliance request, and provide compliance data to the compliance entity.

In some exemplary embodiments, the cloud-based computing resource is further operative to request the metrological information from the selected fuel dispenser in response to the compliance request. For example, the compliance data may be sent to the compliance entity as a formatted compliance report, such as via email or made available for download via the cloud computing resource.

In some exemplary embodiments, the cloud-based computing resource may provide a web portal by which the compliance entity can submit the compliance request. For example, the web portal may provide a list of the fuel dispensers from which the metrological information can be obtained. Preferably, the list of the fuel dispensers shows only fuel dispensers that are currently CAT 3 enabled.

In some exemplary embodiments, each of the fuel dispensers comprises an edge device in signal communication with the cloud-based computing resource. The edge device in such embodiments may be operative to interrogate a pump control node of the fuel dispenser for metrological information about the fuel dispenser, receive the metrological information from the pump control node, and send the metrological information to the cloud-based computing resource.

Another aspect of the present invention provides a fuel dispenser comprising a housing. A flexible dispensing hose and a nozzle attached to the dispensing hose are also provided. Piping internal to the housing conducts flow of fuel from a fuel source to the hose and the nozzle. A flow meter is located along the piping. A control system includes a pump control node. The dispenser further comprises an edge device in signal communication with a cloud-based computing resource. The edge device is operative to interrogate the pump control node of the fuel dispenser for metrological information about the fuel dispenser, receive the metrological information from the pump control node, and send the metrological information to a remote location.

A still further aspect of the present invention provides a method performed at a cloud-based computing resource for determining fuel dispenser metrological compliance at multiple fueling sites each having a plurality of fuel dispensers. One step of the method involves receiving a compliance request from a compliance entity for metrological information from a selected fuel dispenser. According to another step, the compliance request is validated. A further step involves providing compliance data to the compliance entity.

Those skilled in the art will appreciate the scope of the present invention and realize additional aspects thereof after reading the following detailed description of preferred embodiments in association with the accompanying drawing figures.

### BRIEF DESCRIPTION OF THE DRAWINGS

A full and enabling disclosure of the present invention, including the best mode thereof directed to one skilled in the art, is set forth in the specification, which makes reference to the appended drawings, in which:

FIG. 1 is a diagrammatic representation of a system for improved fuel dispenser audit compliance in accordance with an embodiment of the present invention.

FIG. 2 is a perspective view of an exemplary fuel dispenser utilized in the system of FIG. 1.

FIG. 3 is a diagrammatic representation showing certain internal components of the fuel dispenser of FIG. 2.

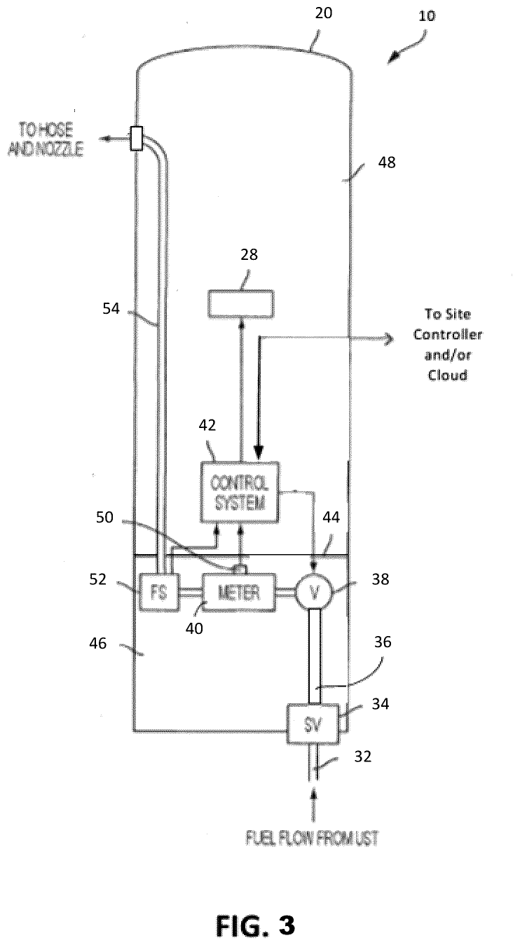

FIG. 4 is a block diagram showing a pump control node (PCN) and edge device utilized in the dispenser of FIG. 2.

FIG. 5 illustrates an exemplary use case for remote access to obtain compliance information.

### DETAILED DESCRIPTION

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

To provide an improved, cost effective, and smaller carbon footprint auditing system and to overcome the disadvantages and inefficiencies of currently available systems, this invention provides a new and novel dispenser auditing system, wherein physical interaction with the equipment at a fueling station is no longer required.

The necessary audit data/report collection is done remotely via a web interface or APIs, eliminating the cost/time involved.

A particular advantage of the new and novel system is that the regulatory entity can remotely audit metrological features of a dispenser.

Another advantage is increased productivity and convenience for the auditor/inspector.

Still another advantage is the flexibility of the auditing authorities to audit dispensers at any date and time as desired.

Yet another advantage is carbon footprint reduction. This environment-friendly approach eliminates printing a long paper receipt that contains the audit report at the dispenser's receipt printer.

Another advantage is that there is no need for the auditor/inspector to drive to or otherwise visit the fueling station.

A further advantage is the cost savings realized by the customer in keeping equipment within regulatory compliance.

CAT 2 devices have access to metrological sealing controlled by physical hardware. Hardware is typically lead wire seals, tamper tape, or other physical sealing methods. These physical access points must be opened or broken and then re-sealed when making metrological changes. The Encore series, available from Gilbarco Veeder-Root (GVR), has a “security wire sealed” toggle or sliding switch in the electronics area.

In contrast, Category 3 (CAT 3) devices have unrestricted access or remote access for configuration and/or metrological parameters. CAT 3 fueling dispensers are typically connected (wired or wireless internet connected to a host server or database) and are thus able to have remote downloads of data or software.

Moreover, CAT 3 devices do not require a “physical” sealing method to access metrological changes. As such, the NCWM Handbook 44 requires them to have an “event logger” (also referred to as the W&M audit trail or log file). This is a list by date and item description for the metrological changes made to the device, stored in RAM of the dispenser electronics. A list of metrological events and formatting for the event logger are detailed within Handbook 44. The event logger (or W&M audit trail) must be made available to an inspector via printing on site or via an electronic copy and must hold up to 1000 events.

Advantageously, unlike CAT 2, CAT 3 allows customers flexibility and gives more efficiency with these changes. It allows remote changes to dispenser settings, thereby turning the dispenser into a smart device for site monitoring and adjustments. CAT 3 is not new to industry certification, but the new and novel system described herein provides a unique architecture that implements a digital report for the regulatory auditor. This fundamentally changes how the regulatory audit and procedure is performed.

By way of example and not limitation, in the present new and novel system and method, CAT 3 dispensers may be remotely connected through the customer subscription-based hub site management program, such as available through Insite360/Invenco. The hub provides real time site data management to provide the value-added services of better uptime, predictive maintenance, inventory management, mobile payment and loyalty payment program management, data security, and website/app integrations. This may be accomplished through the development of a specific web portal for regulatory authorities (auditors) that is linked to a cloud data plane, such as available from GVR/Invenco by GVR.

By way of example, an edge device (e.g., OMNIA) is developed that is connected to the cloud data plane and also connected to the pump control board of the dispenser. Software in the edge device retrieves the regulatory audit data from the pump control board and securely transfers it to the cloud data plane. The edge device uses a communications protocol to interact with the pump control board.

If a dispenser is not connected to the hub site management program (but was setup as a connected dispenser/site), then the dispenser will be in the list for selection but will be shown as “DOWN.” For example, this would occur if connectivity is down between the dispenser and the cloud.

Note that a time window or buffer (e.g., 12 hours) may be provided to allow time for connectivity to be restored whenever there is a disconnection to the hub site management program website. If connectivity is not resolved within this time window, the dispensers may be automatically downgraded to CAT 2. However, during this time window the dispenser display will show as CAT 3 using the ENTER button on the Manager Keypad.

If the dispenser is disconnected from the site management program website and is not re-connected within the time window, the web portal may continue to show the last known status even if the dispenser is now CAT 2.

Preferably, a period of power outage to the dispenser will not be included within the time window. Once power is restored, the dispensers are automatically rebooted. After the reboot, if connectivity is not restored, then the time window starts. However, if the dispenser loses connectivity before the power outage, then the time window may start when the dispenser lost its connectivity.

In operation, the dispenser is connected/registered to the cloud. The pump control board is converted to CAT 3 by a service technician and the CAT 3 features are enabled for the dispenser.

For security purposes, to request the electronic copy of the audit trail report for a CAT 3 dispenser, the W&M inspector according to a preferred embodiment must first access a web portal that is maintained by the dispenser manufacturer. This may be done with a suitable computing device, such as either a laptop or mobile device (e.g., cell phone) that has internet connectivity. The inspector scans the QR code that is within the dispenser next to the serial label or optionally goes to the web address shown on the label beneath the QR Code. The QR code directs one to the web address.

In one embodiment, the auditor may choose to engage physically with the dispenser. In such a case, the W&M inspector arrives at the dispenser and desires to retrieve the audit trail. The W&M inspector utilizes a Manager Keypad to determine or confirm whether the dispenser is setup as CAT 2 or CAT 3. The inspector opens the dispenser upper main door. The site manager may have to provide dispenser keys, may have to provide keys for any custom locks, and may have to disable security alarms or any other security measures. Once the door is open, the Manager Keypad must be available and plugged into the keypad port on the door. Note that the site manager may have to provide a Manager Keypad if it has been removed from the dispenser for security reasons.

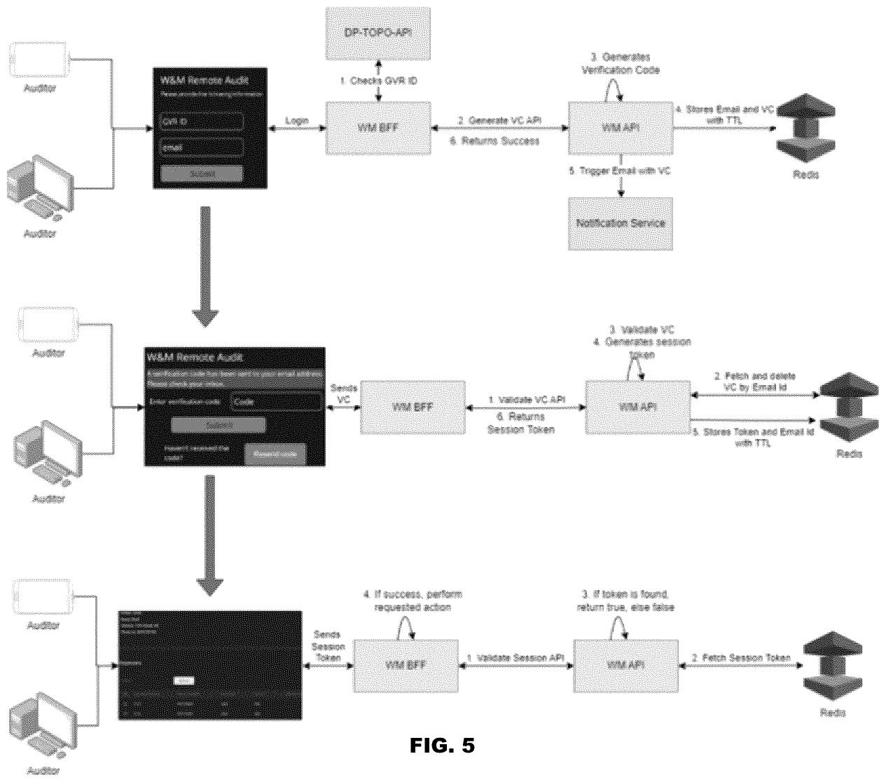

In an example of remote access, a regulatory auditor logs into a secure website portal using their email address and an authorized ID. The portal preferably provides a one-time password to finalize the user's login. After logging in, the auditor selects the dispenser (only CAT 3 enabled dispensers are made available for selection) and requests the system to generate an audit report. The report may then be delivered to the auditor via email or is downloaded from the portal as a PDF document. An exemplary use case for remote access is illustrated in FIG. 5.

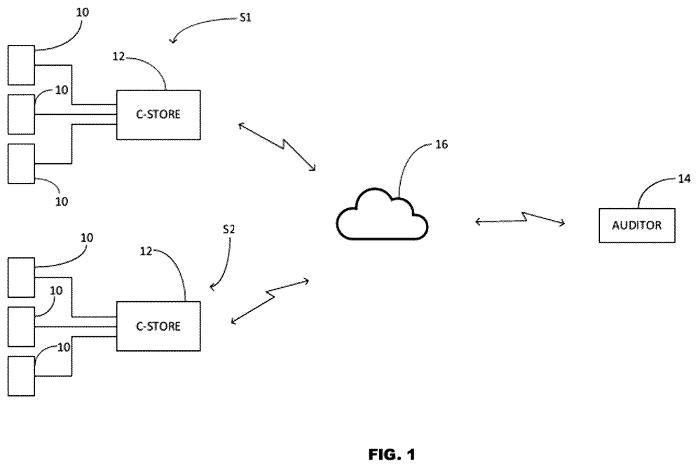

FIG. 1 illustrates an environment in which aspects of the present invention may be utilized. In this regard, a plurality of fueling sites S1, S2, etc. are illustrated, each having a plurality of fuel dispensers 10. The fuel dispensers are located in the forecourt area of the fueling site, and in electrical communication with a point-of-sale (POS) system located in a building such as a respective convenience store (“C-store”) 12. The POS systems authorizes payment for the fuel to be dispensed and allow dispensing to begin.

As noted above, embodiments of the present invention allow access to an audit report by an auditor 14 located remotely from the fueling site(s). In this regard, the audit report is provided via a cloud-based computing resource, such as the indicated at 16, accessible by the auditor 14. As noted, the auditor typically logs into a website portal via the Internet in order to obtain access to the report.

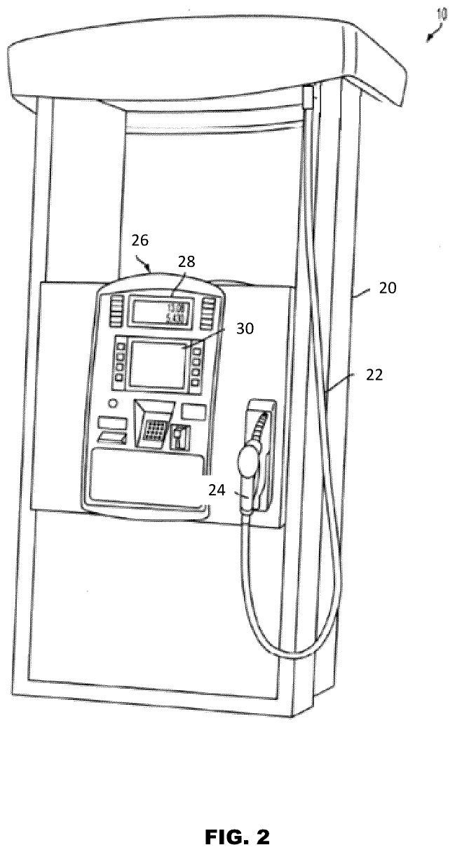

At this point, it is helpful to explain certain additional aspects of fuel dispensers 10. Referring now to FIG. 2, an exemplary fuel dispenser 10 according to an embodiment of the present invention is illustrated. Fuel dispenser 10 includes a housing 20 with a flexible fuel hose 22 extending therefrom. Fuel hose 22 terminates in a fuel nozzle 24 adapted to be inserted into a fill neck of a vehicle's fuel tank. Fuel nozzle 24 includes a manually-operated fuel valve which the user typically opens by squeezing a lever. Various fuel handling components, such as valves and meters, are located inside of housing 20. These fuel handling components allow fuel to be received from a source (e.g., a storage tank) via underground piping and delivered through fuel hose 22 and fuel nozzle 24 to a vehicle's fuel system, e.g. fuel tank.

Fuel dispenser 10 has a customer interface 26. Customer interface 26 may include an information display 28 relating to an ongoing fueling transaction that includes the amount of fuel dispensed and the price of the dispensed fuel. Further, customer interface 26 may include a display 30 that provides instructions to the customer regarding the fueling transaction. Display 30 may also provide advertising, merchandising, and multimedia presentations to a customer, and may allow the customer to purchase goods and services other than fuel at the dispenser.

FIG. 2 is a schematic illustration of internal fuel flow components of fuel dispenser 10 according to an embodiment of the present invention. In general, fuel may travel from an underground storage tank (UST) via main fuel piping 32, which may be a double-walled pipe having secondary containment as is well known, to fuel dispenser 10 and nozzle 24 for delivery. An exemplary underground fuel delivery system is illustrated in U.S. Pat. No. 6,435,204, hereby incorporated by reference in its entirety for all purposes. More specifically, a submersible turbine pump (STP) associated with the UST is typically used to pump fuel to the fuel dispenser 10. However, some fuel dispensers may be self-contained, meaning fuel is drawn to the fuel dispenser 10 by a pump unit positioned within housing 20.

Main fuel piping 32 passes into housing 20 through a shear valve 34. As is well known, shear valve 34 is designed to close the fuel flow path in the event of an impact to fuel dispenser 10. U.S. Pat. No. 8,291,928, hereby incorporated by reference in its entirety for all purposes, discloses an exemplary secondarily-contained shear valve adapted for use in service station environments. Shear valve 34 contains an internal fuel flow path to carry fuel from main fuel piping 32 to internal fuel piping 36.

Fuel from the shear valve 34 flows toward a flow control valve 38 positioned upstream of a flow meter 40. Alternatively, valve 38 may be positioned downstream of the flow meter 40. In one embodiment, valve 38 may be a proportional solenoid-controlled valve, such as described in U.S. Pat. No. 5,954,080, hereby incorporated by reference in its entirety for all purposes.

Flow control valve 38 is under control of a control system 42. In this manner, control system 42 can control the opening and closing of flow control valve 38 to either allow fuel to flow or not flow through meter 40 and on to the hose 22 and nozzle 24. Control system 42 may comprise any suitable electronics with associated memory and software programs running thereon whether referred to as a processor, microprocessor, controller, microcontroller, or the like. In a preferred embodiment, control system 42 may be comparable to the microprocessor-based control systems used in CRIND (card reader in dispenser) type units sold by GVR. Control system 42 typically controls other aspects of fuel dispenser 10, such as valves, displays, and the like. For example, control system 42 includes a pump control board (or pump control node, “PCN”) which typically instructs flow control valve 38 to open when a fueling transaction is authorized. In addition, control system 42 may be in electronic communication with the point-of sale (POS) system (such as a site controller) located at the fueling site. The site controller communicates with control system 42 to control authorization of fueling transactions and other conventional activities. The control system 42 may also be in communication with one or more host servers in the “cloud,” either directly or via the site controller.

A vapor barrier 44 delimits hydraulics compartment 46 of fuel dispenser 10, and control system 42 is located in electronics compartment 48 above vapor barrier 44. Fluid handling components, such as flow meter 38, are located in hydraulics compartment 46. In this regard, flow meter 40 may be any suitable flow meter known to those of skill in the art, including positive displacement, inferential, and Coriolis mass flow meters, among others. Meter 40 typically comprises electronics 50 that communicate information representative of the flow rate or volume to control system 42. For example, electronics 50 may typically include a pulser as known to those skilled in the art. In this manner, control system 42 can update the total gallons (or liters) dispensed and the price of the fuel dispensed on information display 28.

As fuel leaves flow meter 40 it enters a flow switch 52, which preferably comprises a one-way check valve that prevents rearward flow through fuel dispenser 10. Flow switch 52 provides a flow switch communication signal to control system 42 when fuel is flowing through flow meter 40. The flow switch communication signal indicates to control system 42 that fuel is actually flowing in the fuel delivery path and that subsequent signals from flow meter 40 are due to actual fuel flow. Fuel from flow switch 52 exits through internal fuel piping 54 to fuel hose 22 and nozzle 24 for delivery to the customer's vehicle. An example flow switch which may be utilized with embodiments of the present invention is shown and described in U.S. Pat. No. 6,763,974, incorporated fully herein by reference for all purposes.

A blend manifold may also be provided downstream of flow switch 52. The blend manifold receives fuels of varying octane levels from the various USTs and ensures that fuel of the octane level selected by the customer is delivered. In addition, fuel dispenser 10 may comprise a vapor recovery system to recover fuel vapors through nozzle 24 and hose 22 to return to the UST. An example of a vapor recovery assist equipped fuel dispenser is disclosed in U.S. Pat. No. 5,040,577, incorporated by reference herein in its entirety for all purposes.

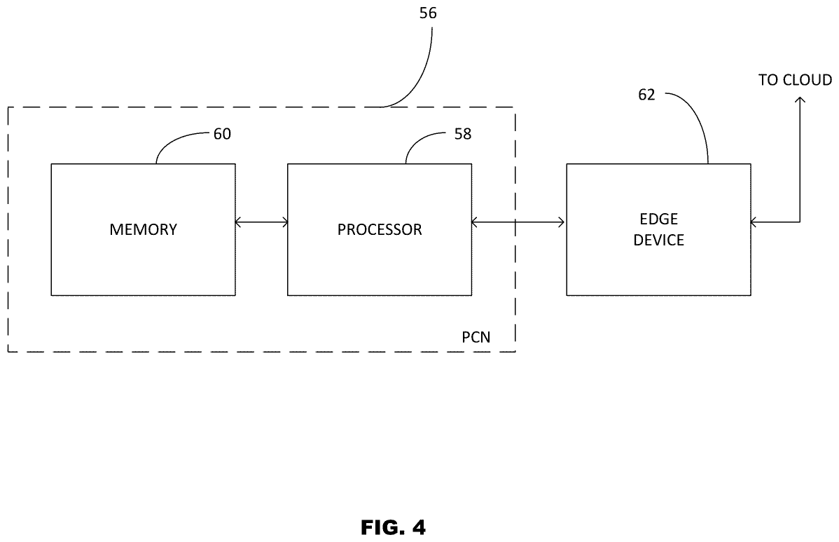

Aspects of the PCN 56 of control system 42 may be explained with reference to FIG. 4. (One skilled in the art will appreciate that “pump control board,” also referred to as PCN, may actually comprises multiple circuit boards as necessary or desired.) In an example embodiment, PCN 56 is used to perform data collection and other processing and management services. In this regard, the PCN 56 may include a processor 58 and a memory 60 in communication with an edge device 62 for communication with the cloud data plane. Specifically, edge device 62 may be any suitable device or circuitry embodied in either hardware, software, or a combination of hardware and software that is configured to receive and/or transmit data from/to a network and/or any other device or module in communication with the control system 42 and/or the POS of the fueling environment (and/or a remote cloud server, either directly or via a router located in the convenience store). Preferably, the edge device 62 may provide secured, e.g. encrypted, communication between the PCN 56 and remote servers or remote computing devices. Such communication may occur through the site controller or directly from the fuel dispenser via wired or wireless protocols, as necessary or desired.

Referring now to FIG. 5, the auditor preferably accesses the system through a web portal via either a mobile phone or a traditional computer (desktop or laptop). The inspector/auditor enters the SITE ID number and an email address. The SITE ID is a number (e.g., a 6-digit number) assigned to the site when setup with the hub. For security and privacy reasons, the requestor's email is not retained by the service provider. The records for the email or phone number expire and are purged several hours after an inquiry. If the SITE ID is unknown, the auditor is able to call the service provider to get the required information.

If the SITE ID number is not recognized (for example, if the site is not setup, or there was a SITE ID number error) then an error message, such as “not found; invalid SITE ID” is displayed on the screen. The inspector must then call the service provider helpline to get the correct SITE ID or to get assistance.

Once the correct SITE ID and email address is provided, the inspector receives in preferred embodiments a verification/authentication code (e.g., via email). The code is then entered and submitted. Typically, the code expires within several minutes for security purposes.

Once the verification code is accepted, a new screen “SITE DETAILS” will appear, showing the site information and a listing of the dispensers that are CAT 3. The inspector then selects the small box next to one or more dispensers.

After selecting the dispenser(s), the ACTIONS button is pressed, resulting in a drop down of menu choices. The inspector then selects either EMAIL REPORTS or GENERATE REPORTS. Selecting EMAIL REPORTS will send the audit trail report in PDF format to the entered email address. Selecting GENERATE REPORTS generates and then downloads a PDF file of the audit trail report. After the download is completed, pressing the Download Report button results in the file being downloaded by the browser to the accessing computer or mobile phone. The report may take up to several minutes to generate.

Many modifications and other embodiments of devices and/or methodology set forth herein will come to mind to one skilled in the art to which they pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A system for determining fuel dispenser metrological compliance at multiple fueling sites each having a plurality of fuel dispensers, the system comprising:
a cloud-based computing resource in operative communication with the fueling sites;
the cloud-based computing resource being operative to:
receive a compliance request from a compliance entity for metrological information from a selected fuel dispenser;
validate the compliance request; and
provide compliance data to the compliance entity.

2. A system as set forth in claim 1, wherein the cloud-based computing resource is further operative to request the metrological information from the selected fuel dispenser in response to the compliance request.

3. A system as set forth in claim 2, wherein the compliance data is sent to the compliance entity as a formatted compliance report.

4. A system as set forth in claim 3, wherein the compliance report is sent to the compliance entity via email.

5. A system as set forth in claim 3, wherein the compliance report is made available for download via the cloud computing resource.

6. A system as set forth in claim 1, wherein the cloud-based computing resource provides a web portal by which the compliance entity can submit the compliance request.

7. A system as set forth in claim 6, wherein the web portal provides a list of the fuel dispensers from which the metrological information can be obtained.

8. A system as set forth in claim 7, wherein the list of the fuel dispensers shows only fuel dispensers that are currently CAT 3 enabled.

9. A system as set forth in claim 1, wherein each of the fuel dispensers comprises an edge device in signal communication with the cloud-based computing resource, the edge device being operative to:
interrogate a pump control node of the fuel dispenser for metrological information about the fuel dispenser;
receive the metrological information from the pump control node; and
send the metrological information to the cloud-based computing resource.

10. A fuel dispenser comprising:
a housing;
a flexible dispensing hose;
a nozzle attached to the dispensing hose;
piping internal to the housing to conduct flow of fuel from a fuel source to the hose and the nozzle;
a flow meter located along the piping;
a control system including a pump control node; and
an edge device in signal communication with a cloud-based computing resource, the edge device being operative to:
interrogate the pump control node of the fuel dispenser for metrological information about the fuel dispenser;
receive the metrological information from the pump control node; and
send the metrological information to a remote location.

11. A fuel dispenser as set forth in claim 10, the fuel dispenser being CAT 3 enabled.

12. A fuel dispenser as set forth in claim 11, wherein the fuel dispenser is operative to downgrade automatically to CAT 2 if connectivity is interrupted for a time period of at least a selected time buffer.

13. A fuel dispenser as set forth in claim 12, wherein the selected time buffer is twelve hours.

14. A fuel dispenser as set forth in claim 10, wherein edge device interrogates the pump control node in response to a request from the remote location.

15. A method performed at a cloud-based computing resource for determining fuel dispenser metrological compliance at multiple fueling sites each having a plurality of fuel dispensers, the method comprising steps of:
receiving a compliance request from a compliance entity for metrological information from a selected fuel dispenser;
validate the compliance request; and
provide compliance data to the compliance entity.

16. A method as set forth in claim 15, further comprising the step of:
prompting the compliance entity to enter information indicating a selected site of the fueling sites about which information is requested.

17. A method as set forth in claim 16, further comprising the step of:
based on the selected site, presenting a list of the fuel dispensers at the selected site.
